(19) United States
(12) Patent Application Publication
(10) Pub. No.: US 2019/0225482 A1
(43) Pub. Date: Jul. 25, 2019

(54) SECURITY POWER CONTROLLER FOR PUMP ON REMOTE FLUID SOURCE

(71) Applicant: IntraGrain Technologies Inc., RM of Sherwood (CA)

(72) Inventors: Landon R. Fahlman, Lumsden (CA); Kyle R. Folk, Regina (CA)

(21) Appl. No.: 16/106,493

(22) Filed: Aug. 21, 2018

(30) Foreign Application Priority Data
Jan. 19, 2018 (CA) 2992367
Jul. 25, 2018 (CA) 3012388

(51) Int. Cl. B67D 7/08; B67D 7/14; B67D 7/32; B67D 7/34; G05D 7/06

(52) U.S. Cl. CPC B67D 7/08; B67D 7/145; B67D 2007/0442; B67D 7/346; G05D 7/0676; B67D 7/32

(57) ABSTRACT

A fluid delivery control system cooperates with a remote fluid source having a fluid pump which dispenses fluid when actuated. The system has a power control switch connected between a power supply and the fluid pump which is operable between an active state supplying power to the pump and an inactive state interrupting power to the pump. A controller operates the switch into the active state for a timed duration upon confirming receipt of a valid user code input into a code receiver of the controller. The controller can report (i) activation of the fluid pump, (ii) the user identification of an operator of the fluid pump, and (iii) volume of fluid dispensed, etc. to a remote central server for logging the data. The data can be subsequently accessed by an owner using a personal computer device logged into the central server over an internet interface.

This application claims foreign priority benefits from Canadian Patent Application 2,992,367, filed Jan. 19, 2018 and Canadian Patent Application No. 3,012,388, filed Jul. 25, 2018.

### FIELD OF THE INVENTION

The present invention relates to a controller for use with a pump on a remote fluid source which restricts use of the pump to authorized persons only, and more particularly, the present invention relates to a controller which records pump usage.

### BACKGROUND

A large majority of farmers typically house their own bulk fuel on their property in which the fueling location may have multiple fuel tanks or fuel sites to access both regular and diesel fuel. Currently there are limited products to protect those tanks from theft. Most commonly used is a padlock and chain wrapped around the handle of the fuel dispensing nozzle to prevent dispensing into a vehicle. Another common method of fuel protection is locking a breaker box using a key so that only those with the key can open the breaker box, and have access to the breaker switches to turn on power to the pumps. With either method, a step requiring a key is necessary, and the protection can be bypassed by breakage of the lock. Existing systems can also inadvertently be left in an unlocked state. In instances where employees are entrusted with keys to have access to the fuel, there remains a concern of the employees using more fuel than they are authorized.

### SUMMARY OF THE INVENTION

According to one aspect of the invention there is provided a fluid delivery control system for use with a remote fluid source having a fluid pump arranged to dispense fluid from the fluid source when actuated and a power supply for supplying power to the fluid pump, the system comprising:

a power control switch adapted to be connected between the power supply and the fluid pump, the power control switch being operable between an active state in which electrical power is supplied to the fluid pump so as to enable actuation of the fluid pump and an inactive state in which the power control switch interrupts connection of the power supply to the fluid pump so as to prevent actuation of the fluid pump;

a code receiver adapted to receive an input code from an authorized user; and

a controller being operatively connected to the code receiver and to the power control switch, the controller having an authorized code stored thereon and being adapted to: (i) compare the input code received from the code receiver to the authorized code stored thereon to determine a match and (ii) change the power control switch from the inactive state to the active state upon determination that the input code matches the authorized code.

The use of a programmable controller which supplies power to a fuel pump responsive to a code input by a user is more reliable than prior art systems in which access to dispense fuel from a remote fuel site can occur simply by breakage of a mechanical lock. By further only activating the pump for a prescribed duration, access to the dispensing of fuel by unauthorized persons is automatically removed upon expiration of the prescribed duration rather than relying on users to remember to lock access to the fuel pump after use. This eliminates the concern of fuel tanks being unlocked overnight or longer after use by authorized persons for example. The system described herein is particularly suited for use with small businesses and farms having a number of employees, for example 1 to 50 employees, to provide more restricted access to the fuel and the ability to track fuel usage more effectively.

In some instances, the fluid delivery control system described herein can track fluid usage in real time so that an operator will be able to track when fluid is accessed as well as the amount of fluid that is dispensed. Owners will feel more confident that their fluid is being used appropriately, and if there is an issue they have more information to help them solve problems related to improper fluid usage. The system can be readily adapted to provide information to an operator using various mobile devices for ease of use while they are on the go.

The controller may be adapted to change the power control switch from the inactive state to the active state for only a limited duration according to a prescribed duration stored on the controller upon determination that the input code matches the authorized code. Preferably the prescribed duration on the controller is programmably adjustable.

The system may further include a shut-off button connected to the controller, in which the controller is arranged to change the power control switch from the active state to the inactive state before expiration of the prescribed duration in response to actuation of the shut-off button.

The controller may include an active mode in which controller is responsive to the code receiver, for example corresponding to normal business hours of operation, and an inactive mode in which the controller is unresponsive to the code receiver, for example corresponding to hours during which business is normally closed. In this instance, the controller preferably includes programming stored thereon and is adapted to operate the controller in one of the active mode or the inactive mode according to a time of day.

When the controller includes a plurality of authorized codes stored thereon, the controller is preferably further adapted to change the power control switch from the inactive state to the active state for a prescribed duration upon determination that the input code matches any one of the authorized codes. In this instance, the controller is preferably also arranged to record the matching input code in a log.

A central server may also be remotely located relative to the controller and in communication with the controller over a communications network, in which the controller includes programming stored thereon so as to be adapted to report an activation of the power control switch to the central server in response to the determination that the input code matches the authorized code.

The controller may be further adapted to report the authorized code that matches the input code to the central server together with the report of the activation of the power control switch.

The central server may also be arranged to generate an alert signal communicated to a user over the communication network in response to receiving a report of the activation of the power control switch from the controller.

Preferably the controller includes a wireless transceiver which is arranged to communicate wirelessly with the communications network to the central server.

When the central server communicates with a plurality of different controllers at differing fluid stations, the controller is preferably adapted to also report a controller ID of the controller to the central server together with the report of the activation of the power control switch.

The central server may further include a web interface and programming stored thereon so as to be arranged to record each reported activation of the power control switch in a log associated with a controller ID of the controller, and allow user access to the log through the web interface using a remote user computer device, for example a smartphone, tablet or other personal computing device.

When a housing is provided to support the controller and the power control switch therein, preferably a tamper switch is also provided on the housing which is arranged to detect opening of the housing to access the controller and the power control switch, in which the controller is adapted to report a tamper signal to the central server upon detection by the tamper switch that the housing has been opened. The central server may be arranged to generate an alert signal communicated to a user over the communication network in response to receiving the tamper signal from the controller.

The system may further include a flow meter adapted to measure a volume of fluid pumped by the fluid pump, in which the controller is in communication with the flow meter and is adapted to record the volume of fluid measured by the flow meter in a log. In this instance, the controller may include programming stored thereon so as to be adapted to report the volume of fluid measured by the flow meter together with an activation of the power control switch to the central server.

There may also be provided an indicator light in communication with the controller, in which the controller is arranged to illuminate the indicator light when the power control switch is in the active state.

Preferably, when a flow meter is adapted to measure a volume of fluid pumped by the fluid pump, the controller is in communication with the flow meter so as to be adapted to calculate a current fill level of the fluid source by subtracting the volume of fluid pumped by the fluid pump from a previously determined fill level of the fluid source.

The controller may be adapted to receive fluid volume data from the central server over the communications network relating to a volume of fluid associated with the fluid source and to determine a current fill level of the fluid source using the fluid volume data reported.

When the controller receives fluid volume data from the central server over the communications network relating to a volume of fluid dispensed into the fluid source from a fluid provider, the controller may be further adapted to calculate a current fill level of the fluid source by adding the fluid volume data to a previously determined fill level of the fluid source.

The system may be used in combination with a user computer device in wireless communication with the controller, in which the controller is adapted to communicate the current fill level wirelessly to the user computer device for display to the user on a display of the user computer device.

According to a second aspect of the present invention there is provided a fluid delivery control system for use with a remote fluid source having a fluid pump arranged to dispense fluid from the fluid source when actuated and a power supply for supplying power to the fluid pump, the system comprising:

a power control switch adapted to be connected between the power supply and the fluid pump, the power control switch being operable between an active state in which electrical power is supplied to the fluid pump so as to enable actuation of the fluid pump and an inactive state in which the power control switch interrupts connection of the power supply to the fluid pump so as to prevent actuation of the fluid pump;

a flow meter adapted to measure a volume of fluid pumped by the fluid pump;

a code receiver adapted to receive an input code from an authorized user; and

a controller being operatively connected to the power control switch and being in communication with the code receiver and the flow meter;

a central server remotely located relative to the controller and in communication with the controller over a communications network;

the controller having a memory storing programming instructions and an authorized code stored thereon and a processor for executing the programming instructions so as to be adapted to: (i) compare the input code received from the code receiver to the authorized code stored thereon to determine a match, (ii) change the power control switch from the inactive state to the active state upon determination that the input code matches the authorized code, and (iii) report the volume of fluid measured by the flow meter together with an activation of the power control switch to the central server.

According to a further aspect of the present invention there is provided a fluid delivery control system comprising:

a plurality of remote fluid sources, each having a fluid source identification and a fluid pump arranged to dispense fluid from the fluid source when actuated, the system comprising:

a fluid provider server storing the fluid source identifications associated with a plurality of different remote fluid sources thereon;

a fluid delivery vehicle having a flow meter adapted to measure a volume of fluid dispensed from the fluid delivery vehicle to a selected one of the remote fluid sources;

a communication device associated with the fluid delivery vehicle which is arranged to communicate the volume of fluid dispensed with the fluid source identification of the selected fluid source to the fluid provider server over a communications network;

a controller operatively associated with the fluid pump of each fluid source including a flow meter adapted to measure a volume of fluid dispensed from the fluid source, the controller being arranged to communicate the volume of fluid dispensed from the fluid source to the fluid provider server together with the fluid source identification of the fluid source;

the fluid provider server being adapted to determine a fluid level in each of the plurality of remote fluid sources based upon the volumes of fluid communicated from the controllers of the fluid sources and the volume of fluid communicated from the communication device associated with the fluid delivery vehicle.

### BRIEF DESCRIPTION OF THE DRAWINGS

Some embodiments of the invention will now be described in conjunction with the accompanying drawings in which:

FIG. 1 is a schematic representation of the fluid delivery control system according to the present invention;

FIG. 2 is a schematic representation of a fluid filling station incorporating the fluid delivery control system according to FIG. 1 therein;

FIG. 3 is an illustration of a display screen of the user computer device when operating in conjunction with the fluid delivery control system.

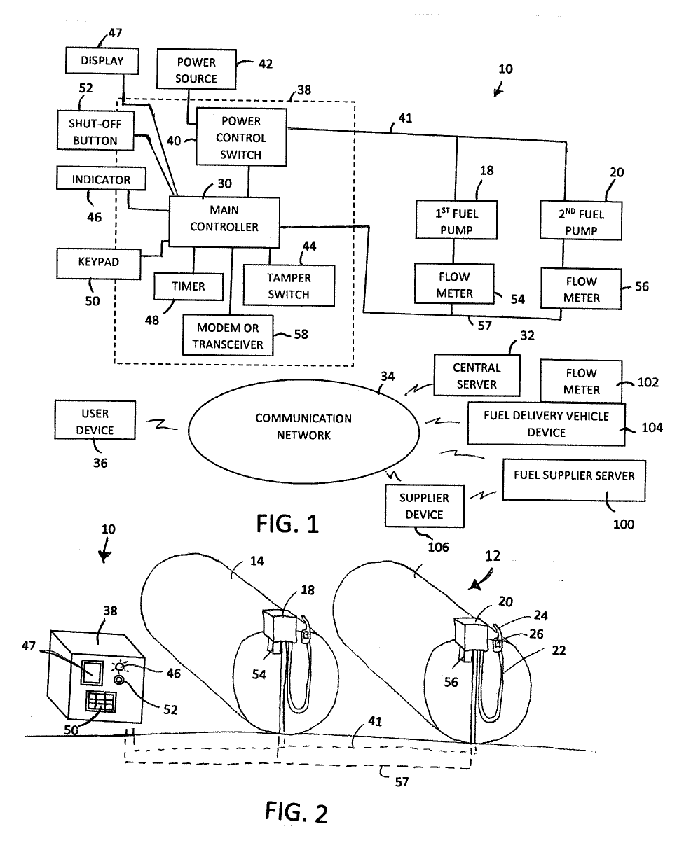

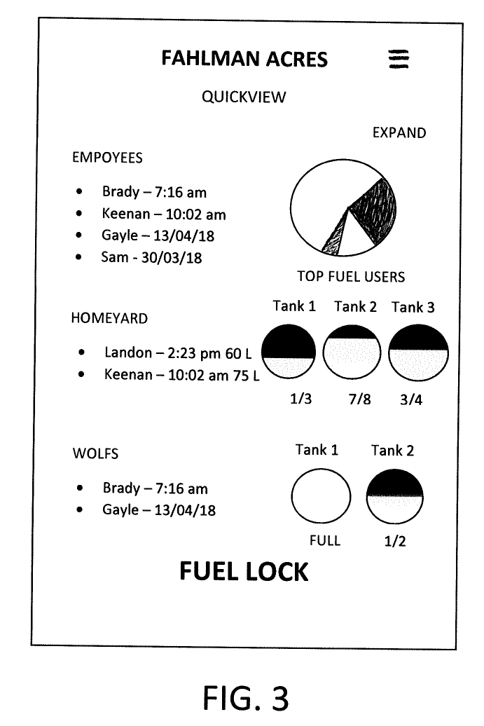

In the drawings like characters of reference indicate corresponding parts in the different figures.

### DETAILED DESCRIPTION

Referring to the accompanying figures there is illustrated a fluid delivery control system and generally indicated by reference numeral 10. The system 10 is particularly suited for use with a fuel station 12 comprised of one or more fuel tanks at a remote fueling location. Each fuel tank includes a fuel pump associated therewith for dispensing fuel from the respective tank. For example, in the illustrated embodiment the fuel station includes a first tank 14 and a second tank 16 having a first fuel pump 18 and a second fuel pump 20 associated therewith respectively.

Each fluid pump includes an elongate flexible dispensing hose 22 supporting a nozzle 24 at the free ends thereof so as to be suited for dispensing fluid into the fluid tank of a vehicle for example. A trigger 26 is provided on a handle in proximity to the nozzle for actuating the pump to dispense fluid from the tank through the nozzle when the fluid pump is supplied with electric power. The control system 10 controls when power is delivered to the fluid pumps as described in the following.

The control system includes a main controller 30 for the fuel station 12 which is in communication with the fluid pump for controlling the delivery of electric power to the pumps respectively. The main controller is a computer device having a memory and a processor for executing programming stored on the memory to perform the various functions of the controller as described in the following.

The system 10 further includes a central server 32 in communication with the main controller over a communications network 34. The communications network can include one or more of a telephone network, local networks, and the Internet for example. The central server 32 comprises one or more computer devices at a single location or over a distributed network, having a memory and a processor for executing programming stored on the memory to execute the various functions of the central server as described in the following.

The central server 32 also communicates over the communications network 34 with a plurality of user devices 36. Each user device 36 is a computer device also having a memory and a processor for executing programming stored on the memory to execute the various functions of the user device as described in the following. Typical examples of user devices include personal computers, tablet computers, smart phones, and the like.

The main controller 30 is typically received within a housing 38 forming an enclosure which fully surrounds of the main controller and which includes a door formed therein to provide access to the controller within the housing. Door is operable between an open condition providing access to the components within the housing and a closed position which restricts access to the components within the housing.

A power control switch 40 is also located within the housing in communication with the main controller which interrupts supply of electrical power from a main power source 42 along a power supply line 41 to the fluid pumps. The power control switch 40 is operable between an active state in which electrical power is supplied from the source to the fluid pump so as to enable actuation of the fluid pumps using the triggers respectively, and an inactive state in which the power control switch interrupts connection of the power supply to the fluid pump so as to prevent actuation of the fluid pumps using the triggers respectively.

The control system 10 further includes a tamper switch 44 which is mounted within the housing so as to detect when the door of the housing is opened. The tamper switch 44 is in communication with the main controller so that detection of the opening of the door of the housing can be communicated to the main controller. The main controller is adapted to report a tamper signal to the central server upon detection by the tamper switch that the housing has been opened.

An indicator light 46 is provided externally on the housing 38 in communication with the main controller 30 therein. The indicator light is adapted to be turned on by the controller when the power control switch 40 is instructed by the main controller to be in the active state.

A display screen 47 is also mounted on the housing 38 so as to be externally visible by an operator. The display screen 47 displays information from the main controller to the operator when the operator interacts with the main controller, for example when programming the main controller or when receiving data from the controller relating to the status of the fluid tanks for example.

The main controller includes a timer element 48 capable of measuring a prescribed duration that the control switch should remain active subsequent to the initiation of activation. The length of the prescribed duration is programmable so as to be readily adjustable by an operator having access to re-program the main controller.

The control system 10 further includes a keypad 50 supported externally on the housing 38 while being in communication with the main controller 30 therein. The keypad functions as a code receiver to allow an operator to input a code into the keypad which communicates the input code to the controller.

Upon receipt of an input code from the keypad, the controller is adapted to compare the input code to a plurality of authorized codes stored thereon corresponding to different users of the system. If the main controller determines that the input code matches one of the authorized codes, then the controller functions to switch the power control switch 40 from the inactive state to the active state thereof. The controller further begins measuring the length of the prescribed duration determined by the timer 48. Upon expiry of the prescribed duration, the controller switches the power control switch 40 back from the active state to the inactive state thereof.

The controller includes a clock function for tracking the time and date. In this instance the controller can be operable between an active mode and an inactive mode. In the active mode, the controller is responsive to an input code that is entered into the keypad by a user for switching the power control switch into the active state when the code matches one of the authorized codes. In the inactive mode, the controller is not responsive to any codes entered into the keypad. That is even if a correct input code which matches one of the authorized codes is entered, the controller does not respond and does not switch the power control switch from the inactive state to the active state. The programming stored on the main controller monitors the time and date determined by the clock function and operates the controller in a selected one of the active mode or the inactive mode based on the time of day by comparing the current time of day to programmed criteria which defines the times when the controller should be in the active mode.

The system 10 also includes a shut off button 52 mounted externally on the housing and which is in communication with the main controller therein. When the shut off button is pressed by a user, a shut off signal is communicated to the controller to switch the controller from the active state to the inactive state immediately before expiration of the prescribed duration.

The system 10 may also include a flow meter supported on each fluid pump. In the illustrated embodiment this corresponds to a first flow meter 54 mounted on the first fluid pump and a second flow meter 56 mounted on the second fluid pump for measuring the volume of fluid dispensed from the respective fluid tank by the respective fluid pump in each instance. Each flow meter and/or pump may include a pump identification associated therewith. In this instance each flow meter detects a flow by the respective fluid pump and measures the volume of fluid being dispensed, followed by signalling to the controller the volume of fluid dispensed together with the pump identification. The flow meters communicate data back to the controller over a suitable signal communication line 57.

The controller is further adapted to record each activation of the power control switch in a respective log by reporting each activation to the central server together with an identification of the corresponding controller. In this instance, the central server may communicate with a plurality of different main controllers located at different remote fluid filling locations respectively. In addition to reporting each activation to the central server, each main controller typically also reports the identification of the corresponding fluid pump being operated and the volume of fluid being dispensed together with the controller ID for each reported activation.

The central server functions to log all data that is reported from one or more main controllers. Each fuelling location includes a user identification associated therewith which identifies the main controller that is in communication with the central server. The central server thus logs all of the reported data in association with the relevant user ID associated with the main controller from which the data is reported.

The central server further includes a web interface in communication between the central server and the communications network through which a user can communicate over the communications network using their personal user device 36. The web interface requires an exchange of validating information between the personal user device 36 and the central server over the web interface to authorize communication of the user device with the central server. Subsequent to authorization, the user device can receive any relevant data that associated with the authorized user identification by communicating the data over the communications network to the user device for display to the user.

The central server is further adapted to send various communications to the user device in the form of alert signals according to various criteria being met. The criteria can be programmed by the user to send different alerts according to the preference of the user. Typically, the central server is adapted to send an alert signal in response to each activation reported to the central server which is associated with the user identification of that user device.

The alert can include identification of the fluid pump being used, the identification of the user associated with the authorized code which matched the input code resulting in an activation, and/or the volume of fluid being dispensed.

In another instance, the alert signal communicated to the user may be in response to the central server receiving a tamper signal from the main controller as a result of the tamper switch detecting opening of the housing.

An alert signal may also be communicated to the user in response to an invalid code being entered into the keypad, or a code being entered at an invalid time when the main controller is programmed to be in the inactive mode.

As described herein, the keypad may be programmed to activate with a code between one and 10 digits in length. Upon determining a matching code, the controller closes the contacts of the power control switch to supply power to the fluid pumps and allow an operator to dispense fluid from the tank. The keypad also sends a signal to the circuit board of the main controller which relays which user code has been typed in and at what time.

A modem or transceiver 58 acts as the communication interface between the main controller and the communications network for sending information back from the main controller to the central server. This allows displaying of the data using suitable programming at the central server or on a user device in communication with the central server. The transceiver 58 may be able to communicate wirelessly with other components by various means including Bluetooth, Wi-Fi,

A suitable alert signal is sent to the user device of the owner of the fluid filling location if notifications have been enabled by the user. Data is stored daily about each user and the corresponding time. The flow meter provides further data which can be associated with each user code to show how much fluid has been dispensed by each user in which the data is logged into a database associated with the user device of the owner.

The system can be enabled to have an email or a text alert sent to the user device whenever a user code is entered in. Optionally the notifications can be turned off during a certain time of day, for example between 8 AM and 6 PM. Although notifications are turned off, data would remain logged on the central server. The central server stores the user code in association with employee names so that when user Ds are displayed on the user device through the web interface, employee names can also be displayed. Various parameters can be set, for example only allowing the keypad to be used between certain hours for example 8 AM to 5 PM, with the option of sending an alert signal to the user device if a valid or invalid code is entered outside of the determined hours that the controller is in the active mode. The tamper switch within the housing would typically be arranged to result in an immediate alert being sent to the user device if the housing is open for any reason.

Entering of a proper code into the keypad will deliver power to the indicator light and operates the contactor of the power control switch to allow the user to operate the fluid pump. The timer associated with the main controller and keypad can be adjusted between zero and 60 minutes before locking and no longer allowing power to the pump subsequent to activation.

The shut off button can also be used by manually depressing by the user for shutting off power to the keypad and main controller of the keypad which in turn inactivates the system.

In one example, up to 1000 different user codes providing authorized activation of the fluid pumps can be used so that each employee in a large organization can have their own code.

A master code provides access for altering the programming of the main controller. Once in a programming mode responsive to a master code, any settings can be changed including the master code itself.

The system 10 is described herein is further arranged to cooperate with a fuel service provider which is equipped with a fuel provider server 100 that is able to communicate with one or both of the central server 32 or the main controller 30 over the communications network 34. The fuel service provider is also equipped with a fleet of delivery vehicles in which each delivery vehicle supports a fuel tank thereon with a suitable fuel pump for dispensing fuel into the remote fuel tanks at different fuel sites.

Each delivery vehicle is further equipped with a flow meter 102 which measures the volume of fuel being dispensed from the vehicle into one of the remote fuel tanks. The communication device 104 is also associated with each vehicle which communicates with the flow meter 102. More particularly the communication device 104 may be a portable computer device such as a tablet having a computer memory storing programming thereon and a processor for executing the programming to execute the various functions of the communication device. The communication device may include a suitable transceiver capable of communicating with the main controller 30 at a fuel site as well as being capable of communicating over a wireless communication network with the fuel supplier server 100.

In some embodiments, the communication device 104 may communicate with a level sensor installed within the tank to communicate a sensed level of fluid within the tank from the level sensor to the communication device, and in turn from the communication device to the fuel provider server 100.

The fuel provider server 100 comprises one or more computer devices at a central location or over a distributed network which includes a memory storing programming thereon and a processor for executing the various functions of the server. More particularly the fuel provider server 100 stores account information thereon relating to each one of a plurality of different fuel customer sites in which each site is provided with one or more fuel tanks located at one or more locations for communication with respective main controllers 30 thereof. A fuel site or customer identification for each of the fuel customer sites is stored on the server together with additional data relating to fuel consumption by the various customers.

The communication device 104 communicates with the flow meter 102 of the delivery vehicle, or receives the measured fuel amount manually entered into the device by an operator of the fuel delivery vehicle, or receives updated fuel tank level from the level sensor installed on the tank. The operator can also enter the customer identification associated with the fuel site, or alternatively the communication device 104 may communicate wirelessly with the transceiver of the main controller 30 of the fuel site or the level sensor at the fuel site to identify the customer number to the communication device. The communication device reports the amount of fuel dispensed and the associated customer ID from the communication device to the fuel provider server 100 over the communications network in real time. Alternatively, the communication of data from the device 104 to the fuel supplier server may be accomplished through a local connection when the fuel delivery vehicle returns to the site of the fuel provider. The fuel provider server 100 can in turn communicates the fuel dispensing data back to the central server 32 and back to the main controller 30 associated with the relevant customer identification.

The fill amounts or new fill level of the tanks may be reported back to the central server and the main controller for purposes in determining or calculating the new fuel level in each fuel tank associated with the customer ID. Alternatively, if the total volume of the tank is known by the central server or the main controller 30, simply indicating that the tanks have been filled is sufficient for the controller or central server to determine the new volume of fuel contained within the tank.

Due to the fuel tanks each being provided with a respective flowmeter 54 or 56, each time fuel is dispensed from the fuel tanks, one or both of the main controller or the central server can calculate the current volume of fluid in the tank by subtracting the dispensed volume of fuel from the previously known tank level when not relying on a level sensor in the tank. The current tank level may be stored as a unit of volume, or alternatively is a ratio of the current volume relative to the total volume of the tank. In this manner, one or both of the main controller 30 and the central server 32 are able to determine the level in each of the tanks in real time at all times by adding a volume of fuel filled into the tank by a delivery vehicle or subtracting the volume of fuel dispensed by one of the fuel pumps from a previously determined tank level to determine the current tank level when no level sensor in the tank is available.

One or both of the current tank level or the volumes of fuel dispensed by users as measured by the flow meters can be reported back from the main controller 30 to the central server 32 and from the central server to the fuel supplier server 100 such that the fuel provider server 100 can keep track of the tank level of all customer tanks. The fuel provider typically further includes a computer device 106 with which an operator interacts for communicating data to and from the fuel supplier server 100. The supplier computer device 100 includes a memory for storing programming thereon and a processor for executing the programming instructions to execute the various functions thereof. The computer device 106 of the fuel provider obtains data from the fuel provider server 100 to keep track of the tank level of all fuel customers and for displaying the tank levels to the operator on a display of the device 106. In one example, a map may be used to indicate all of the fuel site locations associated with different customers thereon together with suitable graphics indicating the level of the tank, for example by indicating high, medium or low levels according to different colour indicators.

The computer device 106 of the fuel provider may also be arranged to automatically generate an invoice and communicate the invoice electronically to the user device 36 associated with a customer identification in response to the communication device 104 of one of the fuel delivery vehicles reporting back through the fuel provider server 100 that a prescribed volume of fuel has been dispensed to one of the tanks associated with the customer ID.

The cooperation between the fuel delivery control system 10 including a main controller 30 at each fuel site together with a fuel provider server 100 provides benefits to the individual user because fill events, fill volume data, or tank levels are reported back from the fuel provider as a useful input to the central server 32 and/or the main controller 30 for determining the fuel level in each of the tanks at the fuel site of a specific customer.

The controller 30 is typically provided in the form of a printed circuit board having a modem, relays and all processing functions for operating the device incorporated therein in cooperation with an OWED display screen 47 such that together with the keypad and other suitable operator input, the operator can change various settings and display commands happening on the device itself.

The printed circuit board may further include a Bluetooth module for example. In some instances all of the vehicles associated with a fuel site have a suitable device thereon that can be recognized wirelessly by the Bluetooth module of the controller 30 once the module on the vehicle is within range of the controller. The device on the vehicle may include an individual user code stored thereon which provides the code input into the main controller to authorize the dispensing of fuel associated with a particular user identification. When applied to fleet vehicles, the security devices that are wirelessly communicated with the controller 30 allow the system to only operate with authorized fleet vehicles. The flow meters may be non-display pulsed output meters which communicate directly with suitable terminals also on the printed circuit board. The controller then takes the amount of each fill and matches it with the authorization code that was entered to the controller to authorize operation of the fuel pumps.

The controller keeps track of various information according to the user identifications and the amounts of fuel being dispensed which are recorded and updates the information in real time. An owner of the fuel site with their user device 36 in communication over the communications network with the main controller or the central server has real-time access to the data for display on the display screen of their device while also being enabled to receive various mobile alerts communicated by email or text message and the like.

The relevant data being tracked by the controller and available to the owner user device 36 is described in the following. For each dispensing event of fuel, (i) the amount of fuel being dispensed, (ii) the identification of the associated tank, and (iii) the user ID used as an authorization code to activate the system are recorded together with (iv) the date and time. The data is stored on the main controller and communicated back to the central server for storage on the server as well. Using the available inputs, one or both of the central server and the main controller can determine the tank level for each tank, the overall amount of fuel dispensed according to each user identification, the ratio of fuel used by each user relative to the total amount of fuel dispensed, the last dispensing event associated with each user ID, and more. One or more fuel sites may be linked to a single owner identification so that all data relating to the associated owner identification is made available to the computer device of the owner which communicates directly with either one of the central server or the main controller.

In addition to the real-time updates of information at the main controller 30 and the central server 32, all tank levels, the price of fuel, and volume of fuel dispensed at each event are also communicated between the central server 32 and the fuel supplier server 100 in real time so that all information is accessible to both servers. Keeping up-to-date tank levels allows the fuel provider to keep up-to-date information for up-to-date invoicing. The fuel provider can also have sufficient information available at their computer device 106 for planning efficient delivery routes to several customers. Using this system, customers contract fuel consumption according to each authorized user while checking tank levels so as to eliminate empty tanks during busy fuel consumption times. The fuel providers also have real-time information to ensure up-to-date invoicing to customers as well as being provided with up-to-date information in real time with regard to the tank levels of different customers to ensure that the customer needs are always met.

The system is efficient for use by the fuel provider as the fuel provider only requires (i) an operator entering an amount of litres filled into a portable communication device 104 or (ii) level data to be automatically communicated to the communication device 104 that carried with the delivery vehicle at the fuel site location where the tank is being filled. That information will then update in real time to the main controller on the user fuel site to update the fill levels in the tanks in addition to allowing the fuel supplier to send an invoice for the amount of fuel dispensed right away from the customer fuel site.

The system is readily adaptable for a variety of different fluid sources beyond fuel tanks. In one embodiment, the fluid delivery control system may be used with a fluid pump for pumping water from a well in the ground. In this instance it would be desirable to track the volume of water being removed from the well using a flow meter on the fluid pump. An authorization code identifying the user of the water pump along with the volume of water removed from the well can then be reported back to a central server by the controller. Similar information can be collected from numerous wells to track overall usage of ground water if desired.

Since various modifications can be made in my invention as herein above described, and many apparently widely different embodiments of same made, it is intended that all matter contained in the accompanying specification shall be interpreted as illustrative only and not in a limiting sense.

1. A fluid delivery control system for use with a remote fluid source having a fluid pump arranged to dispense fluid from the fluid source when actuated and a power supply for supplying power to the fluid pump, the system comprising:
a power control switch adapted to be connected between the power supply and the fluid pump, the power control switch being operable between an active state in which electrical power is supplied to the fluid pump so as to enable actuation of the fluid pump and an inactive state in which the power control switch interrupts connection of the power supply to the fluid pump so as to prevent actuation of the fluid pump;
a code receiver adapted to receive an input code from an authorized user; and
a controller being operatively connected to the code receiver and to the power control switch, the controller having an authorized code stored thereon and being adapted to: (i) compare the input code received from the code receiver to the authorized code stored thereon to determine a match and (ii) change the power control switch from the inactive state to the active state upon determination that the input code matches the authorized code.

2. The system according to claim 1 wherein the controller is adapted to change the power control switch from the inactive state to the active state for a limited duration according to a prescribed duration stored on the controller upon determination that the input code matches the authorized code and wherein the prescribed duration on the controller is programmably adjustable.

3. The system according to claim 2 further comprising a shut-off button connected to the controller, the controller being arranged to change the power control switch from the active state to the inactive state before expiration of the prescribed duration in response to actuation of the shut-off button.

4. The system according to claim 1 wherein the controller includes an active mode in which controller is responsive to the code receiver and an inactive mode in which the controller is unresponsive to the code receiver, the controller including programming stored thereon adapted to operate the controller in one of the active mode or the inactive mode according to a time of day.

5. The system according to claim 1 wherein (i) the controller includes a plurality of authorized codes stored thereon, (ii) the controller is adapted to change the power control switch from the inactive state to the active state for a prescribed duration upon determination that the input code matches any one of the authorized codes, and (iii) the controller is arranged to record the matching input code in a log.

6. The system according to claim 1 further comprising a central server remotely located relative to the controller and in communication with the controller over a communications network, the controller including programming stored thereon so as to be adapted to report an activation of the power control switch to the central server in response to the determination that the input code matches the authorized code.

7. The system according to claim 6 wherein (i) the controller includes a plurality of authorized codes stored thereon, and (ii) the controller is further adapted to report the authorized code that matches the input code to the central server together with the report of the activation of the power control switch.

8. The system according to claim 6 wherein the central server is arranged to generate an alert signal communicated to a user over the communication network in response to receiving a report of the activation of the power control switch from the controller.

9. The system according to claim 6 wherein the controller includes a wireless transceiver which is arranged to communicate wirelessly with the communications network to the central server.

10. The system according to claim 6 wherein the controller is adapted to report a controller ID of the controller to the central server together with the report of the activation of the power control switch.

11. The system according to claim 6 wherein the central server further includes a web interface and programming stored thereon so as to be arranged to record each reported activation of the power control switch in a log associated with a controller ID of the controller, and allow user access to the log through the web interface using a remote user computer device.

12. The system according to claim 6 further comprising a housing supporting the controller and the power control switch therein and a tamper switch on the housing which is arranged to detect opening of the housing to access the controller and the power control switch, the controller being adapted to report a tamper signal to the central server upon detection by the tamper switch that the housing has been opened.

13. The system according to claim 12 wherein the central server is arranged to generate an alert signal communicated to a user over the communication network in response to receiving the tamper signal from the controller.

14. The system according to claim 1 further comprising a flow meter adapted to measure a volume of fluid pumped by the fluid pump, the controller being in communication with the flow meter and being adapted to record the volume of fluid measured by the flow meter in a log.

15. The system according to claim 14 further comprising a central server remotely located relative to the controller and in communication with the controller over a communications network, the controller including programming stored thereon so as to be adapted to report the volume of fluid measured by the flow meter together with an activation of the power control switch to the central server.

16. The system according to claim 1 further comprising an indicator light in communication with the controller, the controller being arranged to illuminate the indicator light when the power control switch is in the active state.

17. The system according to claim 1 further comprising a flow meter adapted to measure a volume of fluid pumped by the fluid pump, the controller being in communication with the flow meter and being adapted to calculate a current fill level of the fluid source by subtracting the volume of fluid pumped by the fluid pump from a previously determined fill level of the fluid source.

18. The system according to claim 1 further comprising a central server remotely located relative to the controller and in communication with the controller over a communications network, the controller being adapted to receive fluid volume data from the central server over the communications network relating to a volume of fluid associated with the fluid source and being adapted to determine a current fill level of the fluid source using the fluid volume data reported.

19. The system according to claim 17 in combination with a user computer device in wireless communication with the controller, wherein the controller is adapted to communicate the current fill level wirelessly to the user computer device for display to the user on a display of the user computer device.

20. A fluid delivery control system for use with a remote fluid source having a fluid pump arranged to dispense fluid from the fluid source when actuated and a power supply for supplying power to the fluid pump, the system comprising:
a power control switch adapted to be connected between the power supply and the fluid pump, the power control switch being operable between an active state in which electrical power is supplied to the fluid pump so as to enable actuation of the fluid pump and an inactive state in which the power control switch interrupts connection of the power supply to the fluid pump so as to prevent actuation of the fluid pump;
a flow meter adapted to measure a volume of fluid pumped by the fluid pump;
a code receiver adapted to receive an input code from an authorized user; and
a controller being operatively connected to the power control switch and being in communication with the code receiver and the flow meter;
a central server remotely located relative to the controller and in communication with the controller over a communications network;
the controller having a memory storing programming instructions and an authorized code stored thereon and a processor for executing the programming instructions so as to be adapted to: (i) compare the input code received from the code receiver to the authorized code stored thereon to determine a match, (ii) change the power control switch from the inactive state to the active state upon determination that the input code matches the authorized code, and (iii) report the volume of fluid measured by the flow meter together with an activation of the power control switch to the central server.
